(19) United States
(12) Patent Application Publication
(10) Pub. No.: US 2009/0225917 A1
(43) Pub. Date: Sep. 10, 2009

(54) PHASE INTERPOLATOR AND CLOCK DATA RECOVERY DEVICE

(75) Inventor: Shingo Takagi, Yoro-gun (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/397,595

(22) Filed: Mar. 4, 2009

(30) Foreign Application Priority Data
Mar. 5, 2008 (JP) 2008-54945

(51) Int. Cl. H04L 7/02

(52) U.S. Cl. 375/359

(57) ABSTRACT

A phase interpolator according to an embodiment of the present invention includes a first mixer group including two mixers which are provided with a clock “D0” having a delay equivalent to a phase difference of 0 degree with respect to a reference clock, and generate and output a clock “D0+2Dc” having a delay equivalent to a phase difference of 0 degree with respect to the reference clock and a delay produced by two mixers, a second mixer group including two mixers which are provided with the clock “D0” and a clock “D90” having a delay equivalent to a phase difference of 90 degrees with respect to the reference clock, and generate and output a clock “D45+2Dc” having a delay equivalent to a phase difference of 45 degrees with respect to the reference clock and a delay produced by two mixers, and at least one mixer which generates and outputs, by using any two of the clocks “D0”, “D90”, and “D45+2Dc”, a clock having a delay equivalent to a phase difference of a predetermined angle with respect to the reference clock and a delay produced by two mixers.

### CROSS REFERENCE TO RELATED APPLICATIONS

This application is based upon and claims the benefit of priority from the prior Japanese Patent Application No. 2008-54945, filed on Mar. 5, 2008, the entire contents of which are incorporated herein by reference.

### BACKGROUND OF THE INVENTION

1. Field of the Invention

The present invention relates to a phase interpolator and a clock data recovery device.

2. Background Art

A phase interpolator is often used, for example, in a clock data recovery device used in a high-speed signal transmission receiver in order to generate clocks having arbitrary phase differences with respect to a reference clock.

Especially, examples of the phase interpolator having a CMOS circuit configuration include an interpolator in which plural simple mixers are combined to generate clocks having arbitrary phases as described in a paper given below, and an interpolator in which a single and more complicated mixer generates clocks having arbitrary phases.

The former have advantages over the latter that its configuration is simpler and the load placed on each mixer is lighter. However, the phase interpolator formed by plural mixers requires, in addition to as many mixers as the number of clocks needed, delay adjusting mixers that adjust delays produced by respective those mixers. This has posed problems such as increase in circuit area and power consumption, increase in line area and line capacitance due to the increase in circuit area, and degradation of frequency characteristics.

Conventional phase interpolators are disclosed, for example, in the paper “A Portable Digital DLL for High-Speed CMOS Interface Circuits, IEEE JOURNAL OF SOLID-STATE CIRCUITS, Vol. 34, No. 5, May 1999, pp. 632-644” and JP-A No. 2004-282360 (KOKAI).

### SUMMARY OF THE INVENTION

An aspect of the present invention is, for example, a phase interpolator including a first mixer group including two mixers which are provided with a clock “D0” having a delay equivalent to a phase difference of 0 degree with respect to a reference clock, and generate and output a clock “D0+2Dc” having a delay equivalent to a phase difference of 0 degree with respect to the reference clock and a delay produced by two mixers, a second mixer group including two mixers which are provided with the clock “D0” and a clock “D90” having a delay equivalent to a phase difference of 90 degrees with respect to the reference clock, and generate and output a clock “D45+2Dc” having a delay equivalent to a phase difference of 45 degrees with respect to the reference clock and a delay produced by two mixers, and at least one mixer which generates and outputs, by using any two of the clocks “D0”, “D90”, and “D45+2Dc”, a clock having a delay equivalent to a phase difference of a predetermined angle with respect to the reference clock and a delay produced by two mixers.

Another aspect of the present invention is, for example, a phase interpolator including a first delay adjusting mixer which is provided with a clock “D0” having a delay equivalent to a phase difference of 0 degree with respect to a reference clock, and outputs a clock “D0+Dc” including a predetermined delay “Dc” and having a delay equivalent to a phase difference of 0 degree with respect to the reference clock, a second delay adjusting mixer which is provided with the output from the first delay adjusting mixer, and outputs a clock “D0+2Dc” including a delay twice as large as the predetermined delay “Dc” and having a delay equivalent to a phase difference of 0 degree with respect to the reference clock, a first mixer which is provided with the clock “D0” and a clock “D90” having a delay equivalent to a phase difference of 90 degrees with respect to the reference clock, and outputs a clock “D45+Dc” including the predetermined delay “Dc” and having a delay equivalent to a phase difference of 45 degrees with respect to the reference clock, a third delay adjusting mixer which is provided with the output from the first mixer, and outputs a clock “D45+2Dc” including a delay twice as large as the predetermined delay “Dc” and having a delay equivalent to a phase difference of 45 degrees with respect to the reference clock, a second mixer which is provided with the clock “D0” and the output from the third delay adjusting mixer, and outputs a clock “D22.5+2Dc” including a delay twice as large as the predetermined delay “Dc” and having a delay equivalent to a phase difference of 22.5 degrees with respect to the reference clock, and a third mixer which is provided with the clock “D90” and the output from the third delay adjusting mixer, and outputs a clock “D67.5+2Dc” including a delay twice as large as the predetermined delay “Dc” and having a delay equivalent to a phase difference of 67.5 degrees with respect to the reference clock.

Another aspect of the present invention is, for example, a clock data recovery device including a receiver which uses a selected clock and data provided from an external source to sample the data based on the clock, and outputs the sampled data, a phase detector which is provided with the output from the receiver, and extracts and outputs phase information of the data, a digital filter which uses the phase information to output phase control information, a controller which outputs a control signal required for controlling the phase of the clock, based on the phase control information, and a phase interpolator which is provided with a reference clock, selects at least one clock from plural clocks generated based on the control signal, and outputs the selected clock to the receiver, the phase interpolator comprising, a first mixer group including two mixers which are provided with a clock “D0” having a delay equivalent to a phase difference of 0 degree with respect to the reference clock, and generate and output a clock “D0+2Dc” having a delay equivalent to a phase difference of 0 degree with respect to the reference clock and a delay produced by two mixers, a second mixer group including two mixers which are provided with the clock “D0” and a clock “D90” having a delay equivalent to a phase difference of 90 degrees with respect to the reference clock, and generate and output a clock “D45+2Dc” having a delay equivalent to a phase difference of 45 degrees with respect to the reference clock and a delay produced by two mixers, and at least one mixer which generates and outputs, by using any two of the clocks “D0”, “D90”, and “D45+2Dc”, a clock having a delay equivalent to a phase difference of a predetermined angle with respect to the reference clock and a delay produced by two mixers.

### BRIEF DESCRIPTION OF THE DRAWINGS

FIG. 1 is a block diagram showing a configuration of a clock data recovery device according to a first embodiment of the present invention;

FIG. 2 is a circuit diagram showing a configuration of a phase interpolator according to the first embodiment;

FIG. 3 is a diagram illustrating an output from a mixer used in the phase interpolator;

FIG. 4 is a circuit diagram showing a configuration of a phase interpolator according to a first comparative example;

FIG. 5 is a circuit diagram showing a configuration of a phase interpolator according to a second embodiment of the present invention; and

FIG. 6 is a circuit diagram showing a configuration of a phase interpolator according to a second comparative example.

### DESCRIPTION OF THE EMBODIMENTS

Phase interpolators and clock data recovery devices according to embodiments of the present invention will be described with reference to the accompanying drawings.

### (1) First Embodiment

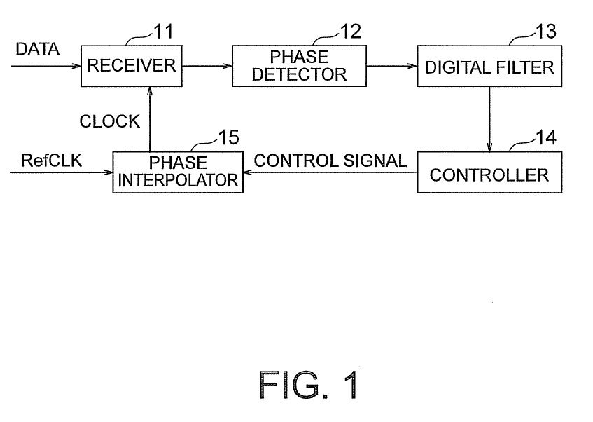

A clock data recovery (hereinafter abbreviated as CDR) device according to a first embodiment has a configuration shown in FIG. 1.

The CDR device includes a receiver 11, a phase detector 12, a digital filter 13, a controller 14, and a phase interpolator 15.

A clock outputted from the phase interpolator 15 and data provided from an external source are inputted in the receiver 11. The receiver 11 samples the data based on the clock, and outputs the sampled data.

The data sampled by the receiver 11 based on the clock is outputted to the phase detector 12. The phase detector 12 extracts phase information from the data, and outputs the phase information to the digital filter 13.

The digital filter 13 uses the provided phase information to calculate and output information required for phase control.

The controller 14 determines, based on the information outputted from the digital filter 13, the phase of the clock to be used and outputs a control signal.

The phase interpolator 15 generates, as described later, plural clocks having different phase differences with respect to a reference clock “RefCLK” provided from an external source, selects at least one clock from the plural clocks according to the control signal outputted from the controller 14, and outputs the selected clock to the receiver 11.

Due to the configuration described above, the CDR device is capable of adjusting the phase so that an optimum clock phase for sampling the inputted data is obtained.

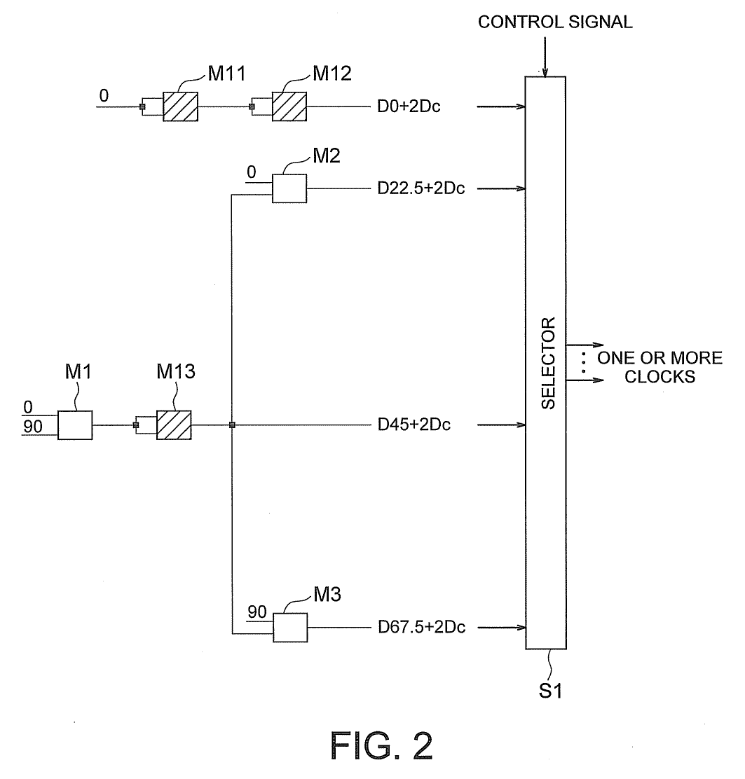

The phase interpolator 15 according to the first embodiment will now be described with reference to FIG. 2, which shows a configuration of the phase interpolator 15. FIG. 2 is a circuit diagram showing the configuration of the phase interpolator 15. In the first embodiment, a quadrant of the reference clock is divided into four to output four clocks having different phase differences.

The four outputted clocks “D0”, “D22.5”, “D45”, and “D67.5” have delays equivalent to phase differences of 0, 22.5, 45, and 67.5 degrees from the reference clock, respectively. In addition, a delay of two mixers “2Dc” is added to each of the outputted clocks as a phase difference.

The phase interpolator according to the first embodiment uses a combination of mixers, rather than a single mixer having a function of adjusting phase differences, thereby simplifying the configuration of each mixer and holding down increase of the number of mixers for adjusting delays produced by the mixers themselves even if the phase division number is large. Each mixer is configured to combine input signals and output a combined signal.

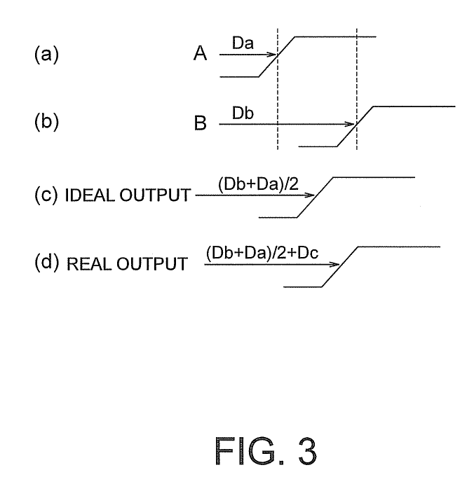

Here, a delay produced when a clock is inputted in a mixer will be explained. A case will be considered where a reference clock having a waveform “A” with a delay “Da” from the reference clock as shown in FIG. 3(a) and a reference clock having a waveform “B” with a delay “Db” from the reference clock as shown in FIG. 3(b) are inputted in the mixer.

An ideal mixer does not delay a clock. Therefore, as shown in FIG. 3(c), a delay “Do1” (from the reference clock) of a waveform outputted from a mixer in the first stage can be expressed by:

Do1=(Db−Da)/2+Da=(Db+Da)/2 (1).

Further, a delay “Do2” (from the reference clock) of a waveform outputted from a mixer in the second stage can be expressed by:

Do2=((Db+Da)/2−Da)/2+Da=(Db+3Da)/4 (2).

However, a delay “Dc” is produced by a real mixer itself. Therefore, as shown in FIG. 3(d), the delay “Do1” of the waveform outputted from the mixer in the first stage can be expressed by:

Do1=(Db−Da)/2+Da+Dc=(Db+Da)/2+Dc (3).

Further, the delay “Do2” of the waveform outputted from the mixer in the second stage can be expressed by:

Do2=((Db+Da)/2+Dc−Da)/2+Da+Dc=(Db+3Da)/4+3/4Dc (4).

In this way, since a phase shift due to the delay “Dc” arises in a mixer in each stage, mixers for adjusting the delays are required.

Here, a case will be considered in which a delay of two mixers “2Dc” is added beforehand to one clock of the two clocks inputted into the mixers (here, the one clock is “Db”). The delay “Do1” of the waveform outputted from the mixer in the first stage is:

Do1=(Db+2Dc−Da)/2+Da+Dc=(Db+Da)/2+2Dc (5).

Further, the delay “Do2” of the waveform outputted from the mixer in the second stage is:

Do2=((Db+Da)/2+2Dc−Da)/2+Da+Dc=(Db+3Da)/4+2Dc (6).

In this way, the output from the mixer is always equal to an ideal delay plus “2Dc”.

Therefore, if inputting the clock into a mixer in the next stage as one input of two inputs, “2Dc” is also added to the output from the next stage, thereby eliminating the need for a delay adjusting mixer. Therefore the total number of mixers can be reduced.

Referring back to FIG. 2, the description of the phase interpolator will be continued.

The phase interpolator according to the first embodiment shown in FIG. 2 includes six mixers M1 to M3 and M11 to M13. The mixers M1 to M3 are required for dividing a quadrant into four, and the other mixers M11 to M13 are provided for adjusting delays that arise in the mixers themselves. The mixers M1 to M3 are examples of first to third mixers of the present invention, respectively, and the mixers M11 to M13 are examples of first to third delay adjusting mixers of the present invention, respectively. Further, the mixers M11 and M12 are an example of a first mixer group of the present invention, the mixers M1 and M13 are an example of a second mixer group in the present invention, and the mixers M2 and M3 are an example of “at least one mixer” of the present invention.

A clock “D0” with a delay from the reference clock that is equivalent to a phase difference of 0 degree is inputted in the delay adjusting mixer M11, and a clock “D0+Dc” is outputted to the delay adjusting mixer M12. The mixer M12 generates and outputs a clock “D0+2Dc”. The mixer 11 combines the clock “D0” with the clock “D0”, and outputs a clock “D0+Dc”. The mixer M12 combines the clock “D0+Dc” with the clock “D0+Dc”, and outputs a clock “D0+2Dc”.

A clock with a delay from the reference clock that is equivalent to a phase difference of 0 degree and a clock delayed by a phase of 90 degrees are inputted in the mixer M1. The mixer M1 generates and outputs a clock “D45+Dc” delayed by an amount equivalent to a phase of 45 degrees and by a delay of “Dc” of the mixer 13. The clock is inputted into the delay adjusting mixer M13, and only the delay “Dc” of the mixer 13 is added to generate a clock “D45+2Dc”. The mixer M13 combines the clock “D45+Dc” with the clock “D45+Dc” to output the clock “D45+2Dc”.

In this embodiment, mixers are provided so that the clock “D45+2Dc” having a delay equivalent to a phase difference of 45 degrees and a delay of two mixers is used for realizing a desired division number. The clock “D0” with a delay from the reference clock that is equivalent to a phase difference of 0 degree and the clock “D45+2Dc” are inputted in the mixer M2, and a clock “D22.5+2Dc” with a delay equivalent to a phase difference of 22.5 degrees is outputted, as expressed by Equation (6). Further, a clock “D90” with a delay from the reference clock that is equivalent to a phase difference of 90 degrees and the clock “D45+2Dc” are inputted in the mixer M3, and a clock “D67.5+2Dc” with a delay equivalent to a phase difference of 67.5 degrees is outputted, as expressed by Equation (6).

In this embodiment, the phase interpolator 15 includes six mixers, and generates four clocks “D0+2Dc”, “D22.5+2Dc”, “D45+2Dc”, and “D67.5+2Dc” as the described plural clocks. The phase interpolator 15 selects at least one clock signal from the four clock signals in accordance with the control signal, and outputs the selected clock signal. FIG. 2 shows a selector S1 configured to select one or more clocks in accordance with the control signal. The four clocks are expressed by D22.5×α+2Dc, where “α” is an integer in the range from 0 to 3.

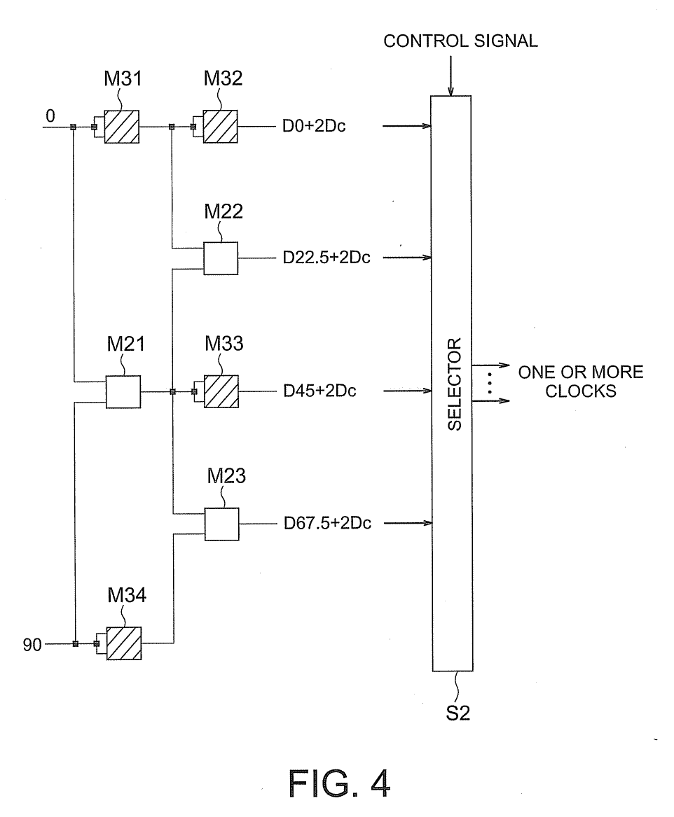

FIG. 4 shows a configuration of a phase interpolator according to a first comparative example. The phase interpolator does not use the technique of the first embodiment in which a delay of two mixers “2Dc” is added beforehand to one of two clocks inputted into mixers. Consequently, the phase interpolator of the first comparative example includes delay adjusting mixers M31 to M34 in addition to mixers M21 to M23 required for dividing a quadrant into four parts, in total seven mixers.

The phase interpolator according to the first embodiment includes six mixers in total, which is one fewer than the phase interpolator of the first comparative example. Accordingly, the circuit area and power consumption can be reduced and, in addition, line capacitance can be reduced to improve frequency characteristics. Consequently, reduction of the circuit area and power consumption and improvement of the frequency characteristics of the clock data recovery device can be achieved according to the first embodiment.

### (2) Second Embodiment

A phase interpolator according to a second embodiment of the present invention will be described. Similar the phase interpolator of the first embodiment, the phase interpolator of the second embodiment is used in the clock data recovery device shown in FIG. 1. However, the phase interpolator of the second embodiment has a configuration that divides a quadrant of a clock into 16 parts.

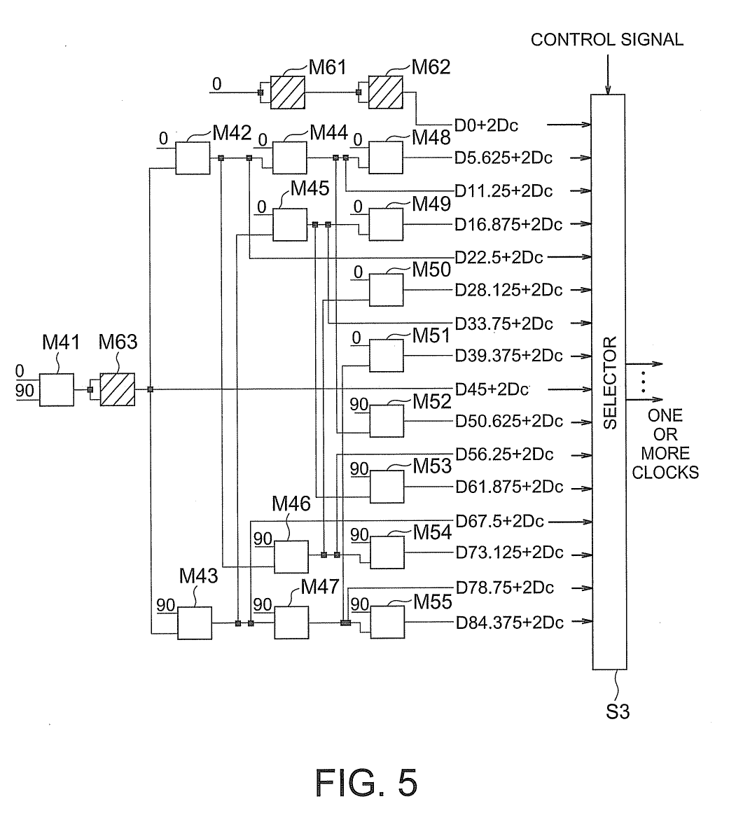

The phase interpolator according to the second embodiment shown in FIG. 5 includes 18 mixers M41 to M55 and M61 to M63. The mixers M41 to M55 are required for dividing the quadrant into 16 parts. The other mixers M61 to M63 are provided in order to adjust delays that arise in the mixers themselves. The mixers M41 to M55 are examples of first to fifteenth mixers of the present invention, respectively, and the mixers M61 to M63 are examples of first to third delay adjusting mixers of the present invention, respectively. Further, the mixers M61 and M62 are an example of a first mixer group of the present invention, the mixers M41 and M63 are an example of a second mixer group of the present invention, and the mixers M42 to M55 are examples of “at least one mixer” of the present invention.

A clock “D0” with a delay equivalent to a phase difference of 0 degree from a reference clock is inputted in the delay adjusting mixer M61, and a clock “D0+Dc” is outputted to the delay adjusting mixer M62. The mixer M62 generates and outputs a clock “D0+2Dc”. The mixer M61 combines the clock “D0” with the clock “D0” to output a clock “D0+Dc”. The mixer M62 combines the clock “D0+Dc” with the clock “D0+Dc” to output a clock “D0+2Dc”.

The clock “D0” with a delay from the reference clock that is equivalent to a phase difference of 0 degree and a clock “D90” delayed by an amount equivalent to a phase difference of 90 degrees are inputted into the mixer M41, and a clock “D45+Dc” delayed by an amount equivalent to a phase difference of 45 degrees is generated and outputted. The clock is inputted in the delay adjusting mixer M63, and only a delay “Dc” of the mixer is added to the clock to output a clock “D45+2Dc”. The mixer M61 combines the clock “D45” with the “D45” to output a clock “D45+Dc”.

By using the clock “D45+2Dc” with a delay equivalent to a phase difference of 45 degrees and a delay of two mixers, as many mixers as a desired division number, which is eight here, are provided as in the first embodiment.

The clock “D0” with a delay of 0 degree from the reference clock and the clock “D45+2Dc” are inputted into the mixer M42, and a clock “D22.5+2Dc” is outputted. The clock “D0” with a delay of 0 degree from the reference clock and the clock “D22.5+2Dc” are inputted into the mixer M44, and a clock “D11.25+2Dc” is outputted. The clock “D0” with a delay of 0 degree from the reference clock and the clock “D11.5+2Dc” are inputted in the mixer M48, and a clock “D5.625+2Dc” is outputted.

The clock “D90” with a delay from the reference clock that is equivalent to a phase of 90 degrees and a clock “D45+2Dc” are inputted in the mixer M43, and a clock “D67.5+2Dc” is outputted. The clock “D90” with a delay from the reference clock that is equivalent to a phase difference of 90 degrees and the clock “D67.5+2Dc” are inputted in mixer M47, and a clock “D78.75+2Dc” is outputted. The clock “D90” with a delay from the reference clock that is equivalent to a phase of 90 degrees and the clock “D78.75+2Dc” are inputted in the mixer M55, and a clock “D84.375+2Dc” is outputted.

The clock “D0” with a delay from the reference clock that is equivalent to a phase of 0 degree and the clock “D67.5+2Dc” output from the mixer M43 are inputted in the mixer M45, and a clock “D33.75+2Dc” is outputted. The clock “D0” with a delay from the reference clock that is equivalent to a phase of 0 degree and the clock “D33.75+2Dc” outputted from the mixer M45 are inputted into the mixer M49, and a clock “D16.875+2Dc” is outputted.

The clock “D90” with a delay from the reference clock that is equivalent to a phase of 90 degrees and the clock “D22.5+2Dc” outputted from the mixer M42 are inputted into the mixer M46, and a clock “D56.25+2Dc” is outputted. The clock “D90” with a delay from the reference clock that is equivalent to a phase of 90 degrees and the clock “D56.25+2Dc” outputted from the mixer M46 are inputted in the mixer M54, and a clock “D73.125+2Dc” is outputted.

The clock “D0” with a delay from the reference clock that is equivalent to a phase of 0 degree and the clock “D56.25+2Dc” outputted from the mixer M46 are inputted into the mixer M50, and a clock “D28.125+2Dc” is outputted. The clock “D0” with a delay from the reference clock that is equivalent to a phase of 0 degree and the clock “D78.75+2Dc” outputted from the mixer M47 are inputted into the mixer M51, and a clock “D39.375+2Dc” is outputted.

The clock “D90” with a delay from the reference clock that is equivalent to a phase of 90 degrees and the clock “D11.25+2Dc” outputted from the mixer M45 are inputted into the mixer M52, and a clock “D50.625+2Dc” is outputted. The clock “D90” with a delay from the reference clock that is equivalent to a phase of 90 degrees and the clock “D33.75+2Dc” outputted from the mixer M44 are inputted into the mixer M53, and a clock “D61.875+2Dc” is outputted.

The phase interpolator of the second embodiment includes 18 mixers, and generates 16 clocks as the described plural clocks. The phase interpolator selects at least one clock signal from the 16 clock signals in accordance with the control signal, and outputs the selected clock signal. FIG. 5 shows a selector S3 which selects one or more clocks in accordance with the control signal. The 16 clocks are expressed by D5.625×γ+2Dc, where “γ” is an integer in the range from 0 to 15.

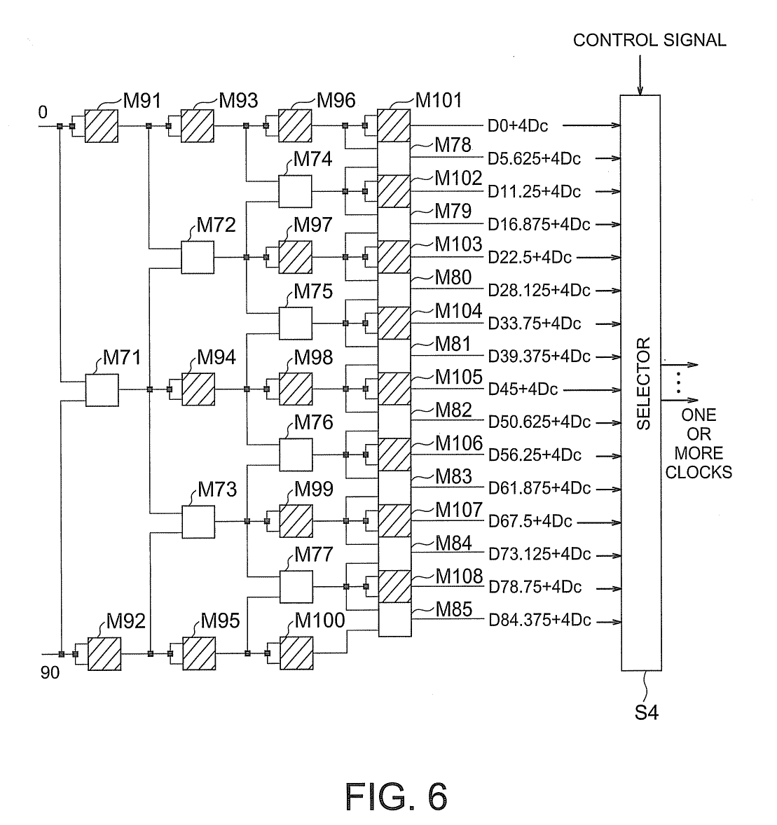

FIG. 6 shows a configuration of a phase interpolator according to a second comparative example. The phase interpolator does not use the technique of the second embodiment in which a delay of two mixers “2Dc” is added beforehand to one of two clocks inputted into mixers. Accordingly, the phase interpolator of the second comparative example includes delay adjusting mixers M91 to M108 in addition to mixers M71 to M85 required for dividing a quadrant into 16 parts, in total 33 mixers.

The phase interpolator of the second embodiment includes 18 mixers in total, which is 15 fewer than the phase interpolator of the second comparative example. Consequently, the circuit area and power consumption can be reduced and, in addition, the line capacitance can be reduced to improve frequency characteristics.

If a quadrant is to be divided into eight, the phase interpolator can be formed by 10 mixers using the same technique as the first and second embodiments. In contrast, if the technique of the first and second comparative examples is used to form such a phase interpolator, 16 mixers are required. In this way, the number of mixers can be reduced by 6 by applying the present invention.

In this case, the mixers M41 to M47 in FIG. 5 are examples of first to seven mixers of the present invention respectively, and the mixers M61 to M63 are examples of first to third delay adjusting mixers of the present invention, respectively. Further, the mixers M61 and M62 are an example of a first mixer group of the present invention, the mixers M41 and M63 are an example of a second mixer group of the present invention, and the mixers M42 to M47 are examples of “at least one mixer” of the present invention.

The phase interpolator in this case includes 10 mixers, and generates eight clocks as the described plural clocks. The phase interpolator selects at least one clock signal from the eight clock signals in accordance with the control signal, and outputs the selected clock signal. The eight clocks are expressed by D11.25×β+2Dc, where “β” is an integer in the range from 0 to 7.

If a quadrant is to be divided into 32 parts, a phase interpolator can be formed by 34 mixers by applying the first and second embodiments. In contrast, the technique of the first and second comparative examples requires 66 mixers. In this way, the present invention can reduce the number of mixers by 32. In this way, the effect of reducing the number of mixers increases with the division number.

The techniques of the first and second comparative examples require about twice as many mixers as the division number (for division into 4, 7 (=4×2−1) mixers are required, for division into 8, 16 (=8×2) mixers are required, for division into 16, 33 (16×2+1) mixers are required, and for division into 32, 66 (32×2+2) mixers are required). Each of the first and second embodiments enables a phase interpolator to be formed by only as many mixers as the division number plus 2.

The embodiments described above are illustrative and various modifications can be made without departing from the technical scope of the present invention. For example, as shown in FIG. 5, the phase interpolator of the second embodiment has a configuration that divides a quadrant into 16. By providing the mixers M61 to M63 and M41 to M47 to a phase interpolator, a configuration required for dividing a quadrant into 8 can be provided. By using the same technique, a quadrant can be divided into 2^{N} (where “N” is an integer greater than or equal to 2), such as 32, 64, 128, and the like.

In this case, the first mixer group of the present invention includes two mixers, the second mixer group of the present invention includes two mixers, and the at least one mixer of the present invention includes 2^{N}−2 mixers. These mixers generate 2^{N} clock signals, expressed by D90×K/2^{N}+2Dc, where “K” is an integer in the range from 0 to 2^{N}−1.

As described above, according to the embodiments of the present invention, there can be provided a phase interpolator and a clock data recovery device capable of reducing the total number of mixers to decrease the circuit area and power consumption and capable of improving frequency characteristics.

While examples of specific aspects of the present invention have been described with respect to the first and second embodiments, the present invention is not limited to those embodiments.

1. A phase interpolator comprising:
a first mixer group including two mixers which are provided with a clock “D0” having a delay equivalent to a phase difference of o degree with respect to a reference clock, and generate and output a clock “D0+2Dc” having a delay equivalent to a phase difference of 0 degree with respect to the reference clock and a delay produced by two mixers;
a second mixer group including two mixers which are provided with the clock “D0” and a clock “D90” having a delay equivalent to a phase difference of 90 degrees with respect to the reference clock, and generate and output a clock “D45+2Dc” having a delay equivalent to a phase difference of 45 degrees with respect to the reference clock and a delay produced by two mixers; and
at least one mixer which generates and outputs, by using any two of the clocks “D0”, “D90”, and “D45+2Dc”, a clock having a delay equivalent to a phase difference of a predetermined angle with respect to the reference clock and a delay produced by two mixers.

2. The phase interpolator according to claim 1, wherein
the at least one mixer includes two mixers, each of which is provided with any two of the clocks “D0”, “D90”, and “D45+2Dc”, and generates and outputs a clock “D22.5×α+2Dc” having a delay equivalent to a phase difference of 22.5×α degrees with respect to the reference clock and a delay produced by two mixers, where “α” is 0 or 3.

3. The phase interpolator according to claim 2, wherein
the at least one mixer further includes four mixers, each of which is provided with any two of the clocks “D0”, “D90”, and “D22.5×α+2Dc”, and generates and outputs a clock “D11.25×β+2Dc” having a delay equivalent to a phase difference of 11.25×β degrees with respect to the reference clock and a delay produced by two mixers, where “β” is an odd number in the range from 1 to 7.

4. The phase interpolator according to claim 3, wherein
the at least one mixer further includes eight mixers, each of which is provided with any two of the clocks “D0”, “D90”, and “D11.25×β+2Dc”, and generates and outputs a clock “D5.625×γ+2Dc” having a delay equivalent to a phase difference of 5.625×γ degrees with respect to the reference clock and a delay produced by two mixers, where “γ” is an odd number in the range from 1 to 15.

5. The phase interpolator according to claim 1, wherein
the at least one mixer includes 2^{N}−2 mixers, where “N” is an integer greater than or equal to 2.

6. The phase interpolator according to claim 1, wherein the first mixer group includes:
a first delay adjusting mixer which combines the clock “D0” with the clock “D0” to output a clock “D0+Dc” having a delay equivalent to a phase difference of 0 degree with respect to the reference clock and a delay produced by one mixer; and
a second delay adjusting mixer which combines the clock “D0+Dc” with the clock “D0+Dc” to output the clock “D0+2Dc”.

7. The phase interpolator according to claim 1, wherein the second mixer group includes:
a mixer which combines the clock “D0” with the clock “D90” to output a clock “D45+Dc” having a delay equivalent to a phase difference of 45 degrees with respect to the reference clock and a delay produced by one mixer; and
a third delay adjusting mixer which combines the clock “D45+Dc” with the clock “D45+Dc” to output the clock “D45+2Dc”.

8. A phase interpolator comprising:
a first delay adjusting mixer which is provided with a clock “D0” having a delay equivalent to a phase difference of 0 degree with respect to a reference clock, and outputs a clock “D0+Dc” including a predetermined delay “Dc” and having a delay equivalent to a phase difference of 0 degree with respect to the reference clock;
a second delay adjusting mixer which is provided with the output from the first delay adjusting mixer, and outputs a clock “D0+2Dc” including a delay twice as large as the predetermined delay “Dc” and having a delay equivalent to a phase difference of 0 degree with respect to the reference clock;
a first mixer which is provided with the clock “D0” and a clock “D90” having a delay equivalent to a phase difference of 90 degrees with respect to the reference clock, and outputs a clock “D45+Dc” including the predetermined delay “Dc” and having a delay equivalent to a phase difference of 45 degrees with respect to the reference clock;
a third delay adjusting mixer which is provided with the output from the first mixer, and outputs a clock “D45+2Dc” including a delay twice as large as the predetermined delay “Dc” and having a delay equivalent to a phase difference of 45 degrees with respect to the reference clock;
a second mixer which is provided with the clock “D0” and the output from the third delay adjusting mixer, and outputs a clock “D22.5+2Dc” including a delay twice as large as the predetermined delay “Dc” and having a delay equivalent to a phase difference of 22.5 degrees with respect to the reference clock; and
a third mixer which is provided with the clock “D90” and the output from the third delay adjusting mixer, and outputs a clock “D67.5+2Dc” including a delay twice as large as the predetermined delay “Dc” and having a delay equivalent to a phase difference of 67.5 degrees with respect to the reference clock.

9. The phase interpolator according to claim 8, further comprising:
fourth and fifth mixers, each of which is provided with the clock “D0” and the output from the second or third mixer, and outputs a clock “D11.25+2Dc” or “D33.75+2Dc” including a delay twice as large as the predetermine delay Dc and having a delay equivalent to a phase difference of 11.25 or 33.75 degrees with respect to the reference clock; and
sixth and seventh mixers, each of which is provided with the clock “D90” and the output from the second or third mixer, and outputs a clock “D56.25+2Dc” or “D78.75+2Dc” including a delay twice as large as the predetermined delay “Dc” and having a delay equivalent to a phase difference of 56.25 or 78.75 degrees with respect to the reference clock.

10. The phase interpolator according to claim 9, further comprising:
eighth, ninth, tenth, and eleventh mixers, each of which is provided with the clock “D0” and the output from the fourth, fifth, sixth, or seventh mixer, and outputs a clock “D5.625+2Dc”, “D16.875+2Dc”, “D28.125+2Dc”, or “D39.375+2Dc” including a delay twice as large as the predetermined delay “Dc” and having a delay equivalent to a phase difference of 5.625, 16.875, 28.125, or 39.375 degrees with respect to the reference clock; and
twelfth, thirteenth, fourteenth, and fifteenth mixers, each of which is provided with the clock “D90” and the output from the fourth, fifth, sixth, or seventh mixer, and outputs a clock “D50.625+2Dc”, “D61.875+2Dc”, “D73.125+2Dc”, or “D84.375+2Dc” including a delay twice as large as the predetermined delay “Dc” and having a delay equivalent to a phase difference of 50.625, 61.875, 73.125, or 84.375 degrees with respect to the reference clock.

11. The phase interpolator according to claim 8, wherein the first delay adjusting mixer combines the clock “D0” with the clock “D0” to output the clock “D0+Dc”;
the second delay adjusting mixer combines the clock “D0+Dc” with the clock “D0+Dc” to output the clock “D0+2Dc”; and
the third delay adjusting mixer combines the clock “D45+Dc” with the clock “D45+Dc” to output the clock “D45+2Dc”.

12. A clock data recovery device comprising:
a receiver which uses a selected clock and data provided from an external source to sample the data based on the clock, and outputs the sampled data;
a phase detector which is provided with the output from the receiver, and extracts and outputs phase information of the data;
a digital filter which uses the phase information to output phase control information;
a controller which outputs a control signal required for controlling the phase of the clock, based on the phase control information; and
a phase interpolator which is provided with a reference clock, selects at least one clock from plural clocks generated based on the control signal, and outputs the selected clock to the receiver, the phase interpolator comprising:
a first mixer group including two mixers which are provided with a clock “D0” having a delay equivalent to a phase difference of 0 degree with respect to the reference clock, and generate and output a clock “D0+2Dc” having a delay equivalent to a phase difference of 0 degree with respect to the reference clock and a delay produced by two mixers;
a second mixer group including two mixers which are provided with the clock “D0” and a clock “D90” having a delay equivalent to a phase difference of 90 degrees with respect to the reference clock, and generate and output a clock “D45+2Dc” having a delay equivalent to a phase difference of 45 degrees with respect to the reference clock and a delay produced by two mixers; and
at least one mixer which generates and outputs, by using any two of the clocks “D0”, “D90”, and “D45+2Dc”, a clock having a delay equivalent to a phase difference of a predetermined angle with respect to the reference clock and a delay produced by two mixers.

13. The device according to claim 12, wherein the at least one mixer includes two mixers, each of which is provided with any two of the clocks “D0”, “D90”, and “D45+2Dc”, and generates and outputs a clock “D22.5×α+2Dc” having a delay equivalent to a phase difference of 22.5×α degrees with respect to the reference clock and a delay produced by two mixers, where “α” is 1 or 3.

14. The device according to claim 13, wherein
the at least one mixer further includes four mixers, each of which is provided with any two of the clocks “D0”, “D90”, and “D22.5×α+2Dc”, and generates and outputs a clock “D11.25×β+2Dc” having a delay equivalent to a phase difference of 11.25×β degrees with respect to the reference clock and a delay produced by two mixers, where “β” is an odd number in the range from 1 to 7.

15. The device according to claim 14, wherein
the at least one mixer further includes eight mixers, each of which is provided with any two of the clocks “D0”, “D90”, and “D11.25×β+2Dc”, and generates and outputs a clock “D5.625×γ+2Dc” having a delay equivalent to a phase difference of 5.625×γ degrees with respect to the reference clock and a delay produced by two mixers, where “γ” is an odd number in the range from 1 to 15.

16. The device according to claim 12, wherein
the at least one mixer includes 2^{N}−2 mixers, where “N” is an integer greater than or equal to 2.

17. The device according to claim 16, wherein the phase interpolator generates 2^{N} clocks as the plural clocks.

18. The device according to claim 17, wherein
each of the 2^{N} clocks has a delay equivalent to a phase difference of 90×K/2^{N} degrees with respect to the reference clock and a delay produced by two mixers, where “K” is an integer in the range from 0 to 2^{N}−1.

19. The device according to claim 12, wherein the first mixer group includes:
a first delay adjusting mixer which combines the clock “D0” with the clock “D0” to output a clock “D0+Dc” having a delay equivalent to a phase difference of 0 degree with respect to the reference clock and a delay produced by one mixer; and
a second delay adjusting mixer which combines the clock “D0+Dc” with the clock “D0+Dc” to output the clock “D0+2Dc”.

20. The device according to claim 12, wherein the second mixer group includes:
a mixer which combines the clock “D0” with the clock “D90” to output a clock “D45+Dc” having a delay equivalent to a phase difference of 45 degrees with respect to the reference clock and a delay produced by one mixer; and
a third delay adjusting mixer which combines the clock “D45+Dc” with the clock “D45+Dc” to output the clock “D45+2Dc”.
